(19) United States
(12) Patent Application Publication
(10) Pub. No.: US 2014/0259392 A1
(43) Pub. Date: Sep. 18, 2014

(54) PERSONAL ASSISTANCE SYSTEM

(71) Applicants: Chih-Cheng Chen, Houston, TX (US); Izuchukwu Samuel ILonze, Katy, TX (US)

(72) Inventors: Chih-Cheng Chen, Houston, TX (US); Izuchukwu Samuel ILonze, Katy, TX (US)

(21) Appl. No.: 14/215,470

(22) Filed: Mar. 17, 2014

Related U.S. Application Data
(60) Provisional application No. 61/794,663, filed on Mar. 15, 2013.

(51) Int. Cl. A61G 7/10; A61G 7/00

(52) U.S. Cl. CPC A61G 7/1001; A61G 7/0005; A61G 7/1003; A61G 7/1007; A61G 7/1042
USPC 5/85.1; 4/573.1; 137/560

(57) ABSTRACT

The application is directed to a system operationally configured to assist individuals with performing one or more activities including, but not necessarily limited to moving from one location to another, showering, using a mirror, using a sink, bathing, using a toilet, performing one or more leisure activities, and combinations thereof. In one aspect, the system may include an assembly and transport member connected thereto, the assembly including a bed and/or bath and/or toilet and/or personal item storage system and/or entertainment system integrated with one or both of smart and manual processes operationally configured to assist individuals with performing one or more activities.

### CROSS-REFERENCE TO RELATED APPLICATIONS

The application is entitled to the benefit of the filing date of the prior-filed U.S. provisional application No. 61/794,663, filed on Mar. 15, 2013.

### STATEMENT REGARDING FEDERALLY SPONSORED RESEARCH OR DEVELOPMENT

Not applicable.

### FIELD OF THE APPLICATION

The application relates generally to a system for assisting persons with mobility and daily living types of activities.

### BACKGROUND

A significant portion of the population has difficulty in transferring into and out of beds, chairs, wheelchairs, toilets and bath tubs. Such difficulties may be attributed to muscular trauma or illness, recuperation from debilitating disease, age-related degeneration of muscles and body movement, or due to the absence of one or more limbs. A system that provides mobility and eases the accomplishment of daily living type of activities is desired.

### SUMMARY

The present application is directed to a system comprising (1) a framework assembly including a width defined by a first location operationally configured for a user of the system to perform one or more activities at said first location and at least a second location operationally configured for a user to perform one or more activities at said second location; and (2) a transport member in communication with the framework assembly, the transport member being operationally configured to move a user between locations of the framework assembly.

The present application is also directed to a system for assisting persons with performing daily activities comprising a framework assembly having one or more covert spaces and a transport member in communication with the framework assembly, the transport member being operationally configured to move a user along the framework assembly.

The present application is also directed to a method of assisting one or more persons with daily activities, the method comprising providing one or more persons with a system including (1) a framework assembly having one or more facilities and (2) a transport member in communication with the framework assembly, the transport member being operationally configured to move a user along the framework assembly in a manner effective to access the one or more facilities.

### BRIEF DESCRIPTION OF THE FIGURES

FIG. 1 is a front perspective view of one simplified embodiment of the present system.

FIG. 2 is a front view of one simplified embodiment of the present system including an individual lying on the bedding of the system.

FIG. 3 is a side view of the system of FIG. 2.

FIG. 4 is a front view of the system of FIG. 2 including an individual raised above the bedding.

FIG. 5 is a simplified view of an individual positioned within a bath tub of the system.

FIG. 6 is a front perspective view of a system illustrating a first compartment or bath tub in an exposed position with the mattress removed.

FIG. 7 is a sectional view of the embodiment of FIG. 6.

FIG. 8 is a front perspective view of an embodiment of the system including a transport in a toilet position.

FIG. 9 is a front view of the embodiment of FIG. 8.

FIG. 10 is a back view of the embodiment of FIG. 8.

FIG. 11 is a top view of the embodiment of FIG. 8.

FIG. 12 is a front perspective view of an embodiment of the system including a transport in a wheel chair position.

FIG. 13 is a front view of the embodiment of FIG. 12 depicting an individual seated in a wheel chair below the transport.

### BRIEF DESCRIPTION

Before describing the invention in detail, it is to be understood that the present daily activity support system is not limited to particular embodiments. It is also to be understood that the terminology used herein is for the purpose of describing particular embodiments only, and is not intended to be limiting.

In one aspect, the application provides an activity support system operationally configured to assist an individual with performing one or more daily activities including, but not necessarily limited to moving from one location to another, showering, using a mirror, using a sink, bathing, using the toilet, performing one or more leisure activities, and combinations thereof. In one aspect, the system may include an assembly including a bed and/or bath and/or toilet and/or personal item storage system and/or entertainment system integrated with one or both of smart and manual processes operationally configured to assist individuals including, but not necessarily limited those that are disabled, partially disabled or the elderly with various daily activities. It is further contemplated that the system may provide one or more attachments for medical devices and other monitoring and/or sensing type devices effective to automatically connect to remote devices such as monitors, telephones, cellular phones and smartphones, computers, e.g., email, in order to relay information about an individual making use of the system. Thus, the system may be operationally configured to signal alarms and relay health status type information in real time as desired.

In another aspect, the application provides a system operationally configured to manually or automatically lift and/or move and/or transfer a suspended or partially suspended person as desired. According to the present system, an individual may be lifted in a sitting, recumbent, or lying position. As such, it is contemplated that various size slings and harnesses may be employed for lifting purposes as desired.

In another aspect, the application provides a system operationally configured to include a mattress or other bedding atop of a bath tub type container whereby the mattress or other bedding may be removed to allow for access to the bath tub. Thus, in one embodiment the system is operationally configured to lift a person off from a mattress or other bedding and lower a person into an exposed bath tub. In another embodiment, lifting, lowering and other transferring of persons may be accomplished via a harness type assembly. In still another aspect, the system may be operationally configured to use the bath tub type container for showering or other hosing applications as desired.

In another aspect, the application provides a system operationally configured to manually or automatically lift a person and transfer a person vertically and laterally between two or more locations. For example, the system may be operationally configured to transfer a person between a mattress or other bedding and a toilet conveniently integrated as part of the system using a motorized hydraulic or manual winch type device or assembly. The system may also be operationally configured to transfer a person to an elevated position effective for lowering the person into a wheel chair or other seating apparatus.

In another aspect, the application provides a system operationally configured to manually or automatically move a mattress or other bedding without damaging the same or otherwise affecting the quality thereof.

In another aspect, the application provides a system operationally configured to manually or automatically close or isolate a toilet component when not in use for (1) aesthetic and/or (2) hygienic purposes.

In another aspect, the application provides a system having one or more emergency type buttons and/or switches that may be strategically and/or conveniently located for ease of use by one or more persons.

In another aspect, the application includes a system operationally configured to provide a storage system strategically and conveniently located above or beside a mattress of the system for storing clothes, towels, pillows, other personal items, and combinations thereof.

In another aspect, the application provides a system including an integrated control panel for both manual and automatic operation effective to enable full and/or partial operation of the system components.

In another aspect, the application provides a system having water proof type electrical panels that may be operationally configured for manual override.

In another aspect, the application provides a system having a touch screen or other computer operated display for operation command inputs and/or voice command inputs and/or other command inputs including physical gestures, eye blinking and other means of communication as understood by persons of ordinary skill in the art of health care.

In another aspect, the application provides a system that may be provided in a complete assembly form or be provided unassembled for assembly as desired. Thus, in another aspect, the system may be transported unassembled from one location to another location as desired.

In another aspect, system installation may be standalone or accomplished via a winch conveyance system mounted to a fixed permanent or temporary framework or other structure.

In another aspect, the application provides a system including a modularized rail track for transferring a person from a first location along various system components to a second location. The system may be assembled according to the shape of a target location or space for assembly, e.g., a room, a platform or other surface. The system may also include the predetermined location of one or more system components such as bedding, a toilet, a sink, a mirror, a wheelchair loading area, a bath tub, a telephone, a television, a desktop, one or more electric outlets, one or more ethernet outlets, one or more cable outlets, one or more telephone plugs (“phone jacks”), one or more fire sprinklers, one or more fire extinguishers, and combinations thereof.

In another aspect, the application provides an automatic system operationally configured to transport an individual to a toilet of the system at one or more predetermined times as desired. A waterproof remote controller may be set up for the exact travel distance of an individual from a first location to a second location, e.g., from a mattress of the system to a toilet of the system.

In another aspect, the application provides a manual system for powerless operation of the system.

In another aspect, the application provides a system including an auto-alert in communication with one or more remote devices for communication type purposes.

In another aspect, the application provides a system having a backup battery programmed to automatically return a person to a mattress or bed of the system in emergency situations or during power outages.

In another aspect, the application provides a system having one or more safety harnesses controlled by a winch or other hoist or pulley system. In one embodiment, the one or more safety harnesses are not operable until a circuit is completed triggering a motion switch that will enable the winch or pulley system to operate.

In another aspect, the application provides one or more conveyance tracks including one or more tracks for the upper body or torso and one or more tracks for the legs. Additional tracks may be added as desired.

In another aspect, the application provides a system that may built to scale. In most health care type operations, the system may include a lifting mechanism rated up to at least 453.6 kg (1000 pounds). In another embodiment, the system may include a lifting mechanism rated up to at least 136.1 kg (300 pounds).

In another aspect, the application provides a system including a lifting mechanism equipped with a scale for weighing a target individual.

In another aspect, the application provides a system that may be joined or otherwise arranged as a series of personal units including shared facilities including shared toilets and/or mirrors and/or bath tubs and/or showers and/or electric outlets and/or ethernet outlets and/or cable outlets. In one example, a system operationally configured for use by an elderly married couple may include two beds, one for each person, and a single toilet and/or bath tub and/or shower and/or work surface as desired.

In another aspect, the application provides a system equipped with one or more medical devices, leisure devices or other conveniences attachable to a frame or other structure of the system.

In another aspect, the application provides a system operationally configured to lift persons in a manner effective to orient a person with his/her legs in a vertical position underneath the person's torso.

In another aspect, the application provides a system having hydraulics or other mechanisms to control and/or adjust the elevation of a mattress or other bedding of the system and also to incline the same.

In another aspect, the application provides a system operationally configured to folded and/or stow away one or more mattresses and/or other bedding.

In another aspect, the application provides safety handles or bars for protecting a person from falling. For example, the system may include safety handles, bars or the like near a toilet, along the sides of a mattress or other bedding, near a sink and/or other locations as desired. In one embodiment, a head piece may be provided, the head piece may be in communication with one or more bars for locking and/or unlocking a head piece.

In another aspect, the application provides a system including a mattress that may be folded sideways or downward from its in use position to allow access to a bath tub located there under.

In another aspect, the application provides a system including a frame providing a bedding location and a bathing location, the bedding location being adjacent the bathing location.

In another aspect, the application provides a bath tub constructed from one or more materials as desired. In one particular embodiment, a bath tub may be constructed from one or more nano-waterproof materials for fast drying of the bath tub surface.

In another aspect, the application provides a shower handler that may be manually controlled by a swivel bar or powered to a person's hand position. In the alternative, a shower handler may be automatically controlled in sequences to direct water to various parts or sections of a person's body.

In another aspect, the application provides a system including a water heater equipped under or beside the mattress or other bedding and below a head piece operationally configured to provide warm water at a desired temperature to a sink, bath tub, shower, or combinations thereof as desired.

In another aspect, the application provides a system in fluid communication with a separate water and/or plumbing system.

In another aspect, the application provides a system including a water temperature sensor and a related display for user friendly reference.

In another aspect, the application provides a system wherein water temperature limits may be programmed, the system further including a temperature related alarm as desired.

In another aspect, the application provides a system having one or more emergency buttons for automatically opening passive ports to quickly drain water from the bath tub as desired.

In another aspect, the application provides a system programmed to include a maximum shower duration as desired.

In another aspect, the application provides a system including a bath tub having one or more therapeutic type water jet heads as understood by the skilled artisan.

In another aspect, the application provides a system including a bathing unit having a pressured plug that may be (1) set manually or by a power source prior to a person bathing and later (2) pulled manually or by a power source after a person finishes bathing.

In another aspect, the application provides a system having an automatic water level detector operationally configured to automatically drain water if and when the water reaches a predetermined level—the detector may also alert a person as to different stages (levels) of rising water prior to reaching a maximum set level.

In another aspect, the application provides a system including a bathing unit constructed to include a base effective to promote directional water drainage. In one simplified example, the base may include a sloping surface.

In another aspect, the application provides a system including an air blower for drying a bathing unit such as a bath tub or shower prior to covering the same with a mattress or other bedding.

In another aspect, the application provides a system including a bath tub made from one or more fire resistant materials and/or having outer panels made from one or more fire resistant materials for protecting an individual during a fire. The system may also be provided with an oxygen supply line that may be used or activated under certain fire emergency modes other when oxygen may otherwise be desired. Thus, it is contemplated that the system may be linked with the fire alarm system of the building, home or other structure housing the system.

In another aspect, the application provides a system wherein all moveable system components may be equipped with a power back-up system.

In another aspect, the application provides a system having a monitoring device equipped with power back-up system.

In another aspect, the application provides a system including a blood pressure monitoring device for temporary or permanent connection and use as desired. The system may include a program to notify the user of the system of one or more times for blood pressure checks. Notification may be via verbal command, chimes or other sounds, vibrations, color coded light notification, and combinations thereof. It is further contemplated that blood pressure measurements may be recorded and/or graphed for historical record keeping or for evaluation purposes.

In another aspect, the application provides a system including a program to notify the user of the system of one or more times for administering medicines. Notification may be via verbal command, chimes or other sounds, vibrations, color coded light notification, and combinations thereof.

In another aspect, the application provides a system including a voice activated and voice controlled dialing system for making emergency telephone calls.

In another aspect, the application provides a system including a mechanical massage system. For example, a mattress or chair may be equipped with a massage system as understood by persons of ordinary skill in the art of massage furniture and the like.

In another aspect, the application provides a system including a retractable side table top or other work surface that a system user may manipulate as desired for eating purposes and/or other table top related activities.

In another aspect, the application provides a system having an entertainment system incorporated therein for playing and listening to music, television, online video, online audio, and combinations thereof. Thus, the system may include a stereo type system, a television, personal computer adaptability, MP3 player adaptability, smart phone adaptability, desktop computer and/or computer laptop and/or tablet computer plug-ins, sound speakers, headphones, and combinations thereof. It is also contemplated that one or more smart phone type applications or “app” may be used to operate one or more system components.

In another aspect, the application provides a self-contained system including all necessary water sources, power sources, plumbing, piping, electrical wiring, electrical connections and outlets, cable wiring including high speed cable broadband wiring, cable connections, Ethernet connectors, modular connectors, USB sockets, and combinations thereof.

In another aspect, the application provides a system equipped with charging ports for MP3 players, smart phones, tablet computers, laptop computers, desktop computers and other electronic devices as desired.

In another aspect, the application provides a system including a shower curtain that may be manually or automatically lowered from a top support structure of the system for privacy purposes including, but not necessarily limited to when the system user is reading, bathing, sleeping or otherwise requires or desires privacy.

In another aspect, the application provides a system for moving a bedridden individual as desired to assist in the prevention of forming bed sores.

In another aspect, the application provides a system including oxygen supplies, water supplies and intravenous bag supports as desired.

In another aspect, the application provides an assembly including a sleeping member and a bathing member in transport communication with regard to transporting individuals from the sleeping member to the bathing member and vice versa.

In another aspect, the system may include a tub constructed from one or more puncture resistant materials. A tub of the system may also be operationally configured to withstand external forces and support a weight thereon. Thus, it is contemplated that the system may include a cover for a tub providing a secure space for use during disaster type events such as tornados, earthquakes, hurricanes, and combinations thereof.

In another aspect, the application provides a framework assembly including electrical wiring communicable with one or more electrical devices, alarms, microphones, speakers, and combinations thereof.

### DISCUSSION

Herein, the phrase “covert space” refers to a space that may be hidden during use of the system. The phrase “privacy member” may refer to drapes, curtains, shades, screens, doors, blinds, shutters, and combinations thereof effective to isolate an individual using the system from being seen and/or heard by others. The term “bath” may include a bath tub and/or a shower type facility.

To better understand the novelty of the assembly, system and method of use thereof, reference is hereafter made to the accompanying drawings. In one simplified embodiment, a suitable system may include an assembly comprising a framework operationally configured to provide one or more persons assisted and/or unassisted access to one or more accommodations or facilities. Suitable accommodations or facilities may include, but are not necessarily limited to bedding, toilets, toilet paper dispensers, sinks, trash receptacles, mirrors, dirty clothes hampers, baths, closet space, stands, table tops, safety guards, side rails, hangers, entertainment systems, light sources, communication items, electric outlets, alarm signals, microphones, speakers, access points for gaining access to one or more mobility assistance devices, ramp type devices for receiving rolling devices, and combinations thereof. Suitable rolling devices may include, but are not necessarily limited to wheelchairs, carts, shower chairs, scooters, hospital beds, medical equipment, overbed tables, and combinations thereof. Suitable mobility assistance devices include, but are not necessarily limited to wheelchairs, walkers, scooters, and combinations thereof. Suitable communication items include, but are not necessarily limited to one or more internet connections, one or more phone connections, and combinations thereof. Suitable medical equipment may include, but is not necessarily limited to medical equipment commonly used in hospital rooms and the like, for example, IV stands, cardiac equipment, defibrillators, monitoring equipment, and combinations thereof. Monitoring equipment may include, but is not necessarily limited to equipment used for cardiac monitoring, hemodynamic monitoring, respiratory monitoring, neurological monitoring, blood glucose monitoring, body temperature monitoring, and combinations thereof. The framework assembly of the present system is not limited in design but rather the framework assembly may be arranged according to any number of combinations operationally configured to provide a particular arrangement for a given user as desired or according to particular room or space requirements or limitations. For example, a left handed individual making use of the present framework assembly and system may desire toilet access on a particular side of the bedding different from a right handed individual. Likewise, the placement of a window and/or entry door to a room that houses the framework assembly and system may determine the arrangement of one or more system components. In addition, the framework assembly may include one or more compartments (open and/or closed compartments) operationally configured for storage purposes as desired.

With attention to FIG. 1, one suitable system 100 may include a framework assembly defined by a base member 5 (hereafter “base 5”) operationally configured to support one or more system members thereon. Suitably, the base 5 operates as a support surface and/or attachment surface for one or more support beams 10 in a manner effective to maintain one or more elevated cross beams 12 connected thereto in a substantially static orientation during use. As shown in FIG. 1, the one or more support beams 10 may include vertical members and horizontal members forming a box like configuration. In another embodiment, the one or more support beams 10 may include vertical members only. The one or more cross beams 12 may include substantially straight members aligned in a parallel fashion as depicted in FIG. 1. In other embodiments, the one or more cross beams 12 may include one or more non-straight shaped members as desired. Cross beams 12 may include a similar shape or one or more cross beams 12 may include dissimilar shapes from the other cross beams 12 as desired.

Suitably, the one or more cross beams 12 are operationally configured to provide one or more travel paths for a user of the system 100. Without limiting the invention to a particular mode of operation, the one or more cross beams 12 may include tracks, guides, railing or one or more other mechanisms operationally configured to transport one or more individuals a desired distance up to about the length of one or more of the cross beams 12 as desired.

Still referring to FIG. 1, the system 100 may also include a mobile transport member 14 (hereafter referred to as a “transport”) in communication with the framework assembly. In particular, the transport 14 is in communication with one or more cross beams 12 in a manner effective to travel along the one or more cross beams 12 to lift and/or transport an individual to one or more locations along the system 5. In the embodiment of FIG. 1, the transport 14 is shown as being located within the support beams 10, which may be referred to herein as a “static position” or “default position” of the transport 14.

In addition to the ability to travel along the one or more cross beams 12, the transport 14 may also be equipped to securely lift and lower an individual vertically as desired (as explained in detail below). As such, the one or more cross beams 12 are operationally configured to support the weight of a transport 14 and at least the weight of an individual suspended therefrom. In one embodiment, the one or more cross beams 12 may support a weight up to about 680.4 kg (1500.0 pounds).

In the embodiment of FIG. 1, the base 5 is effective as a support surface for one or more accommodations or facilities as desired. For example, in this embodiment the system 100 includes a first compartment 15 disposed between the support beams 10, a toilet 16 and a landing 17 for receiving a wheelchair or other seating apparatus as desired. In one embodiment, the landing 17 may include a substantially planar upper surface. In another embodiment, the landing 17 may include one or more non-planar surfaces, e.g., a ramp for receiving rolling devices thereon. Likewise, the base 5 may include a substantially planar upper surface or one or more non-planar surfaces as desired. One base 5 may be provided in a ready to use orientation, e.g., a one piece substantially planar member as shown in FIG. 1. In another embodiment, the base 5 may be operationally configured to be folded. In still another embodiment, the base 5 may be provided in two or more individual sections for assembly.

In the embodiment of FIG. 1, the system 100 includes a first accommodation or facility in the form of a first compartment 15 defined by sidewalls operationally configured to support bedding such as a mattress 18 thereon. The first compartment 15 may be referred to as a covert space in that the first compartment 15 may be hidden away from view when covered by a corresponding mattress 18. As such, entry to the first compartment 15 may be accomplished by removing the mattress 18 to expose the inner surface of the first compartment 15. In another embodiment, the first compartment 15 may include a top cover operationally configured to close off the compartment 15 and support a mattress 18 or other item thereon. The first compartment 15 of FIG. 1 may be provided as a storage compartment and/or as a bath tub including one or more water dumps 20 for removing water as desired. Thus, one benefit of the present system 100 is the ability to maximize the use of space by configuring the system 100 to provide one or more accommodations or facilities or other components that may serve a plurality of roles.

As desired, the present system 100 may include plumbing lines for receiving and otherwise transporting water and toilet waste via external plumbing such as the plumbing of a house, building or other structure housing the present system 100. In one simplified embodiment, the system 100 may include a toilet guide 22 operationally configured to include a pipe for transporting water and other chemicals to the toilet 16 and removing waste from the toilet 16. In addition, the system 100 may include one or more pipes in fluid communication with one or more water inlets and outlets of the bath tub 15, including a water line in fluid communication with a shower head.

In another embodiment, the system 100 may include a self contained water supply and sewer collection system as desired. Thus, the system 100 may include one or more water supplies and a water heater as desired, the water supply being in fluid communication with the bath tub 15, shower head if present, and the toilet 16. In another embodiment, the bath and toilet of the system 100 may include separate water sources.

In another embodiment, the system 100 may include a sink and faucet in fluid communication with an internal water supply and/or an external water supply. In addition, the system 100 may include a waste collection compartment in fluid communication with the toilet 16, bath tub 15 and sink. Thus, the system 100 may also include a chemical type storage tank for cleaning waste collection compartments and flow lines. In an embodiment where the waste collection compartment is not in communication with external plumbing, waste stored within the system 100 may be removed as desired, e.g., pumping the collected waste into a removable tank or other container for proper disposal.

System 100 water sources and waste collection compartments may be located as desired. In one embodiment, one or more of the water sources may be located within the base 5. In another embodiment, one or more of the water sources may be located within the toilet guide 22. In still another embodiment, one or more water sources may be located on the base 5 in a container, the top and sides of which may be employed for other activities, e.g., use the top of the container as a work top or seat, include hangers, bends or other items on the sides of the container for storage purposes.

Still referring to FIG. 1, the system 100 may also include a table or bench top 24 providing a work top for eating, reading, card playing, using a computer or keyboard as well as other table top activities. In one embodiment, the table 24 may be moveable vertically and/or horizontally and/or the table 24 may be rotated and/or folded and put away to the side of the mattress 18 as desired.

Turning to FIGS. 2 and 3, the transport 14 may include a lift system including one or more safety harnesses 26, belts, straps, handles or other support devices operationally configured to safely lift, lower and transport an individual 200 back and forth between multiple locations according to the system 100 accommodations or facilities present and as dictated according to the design of the cross beams 12 employed. In one embodiment of use, an individual's 200 limbs may be inserted through loops attached to the one or more harnesses as shown (see 26 in FIG. 3). Suitable harnesses may include straps including adjustable straps. In one embodiment, the straps may include adjustable hook and loop type fasteners. In another embodiment the straps may include hooks and/or clips. In another embodiment, the straps may include a belt type securing device as understood by the skilled artisan. In other embodiments the lift system may include a handle bar type device allowing an individual 200 to independently raise his/her head and/or torso as desired.

In another embodiment, a lift support surface may be placed underneath an individual 200 for transport purposes. Such lift support may include a sling type device 28 or a substantially flat member for supporting and transporting an individual 200 therein (see FIG. 4). In still another embodiment, the transport 14 may be operationally configured to lift the mattress 18 or other bedding as desired. As desired, the one or more safety harnesses 26 may be permanently attached or releasably attached to the transport 14. Thus, the system 100 may include one or more storage compartments for housing the one or more safety harnesses 26 and sling type or solid support devices 28 when not in use. Likewise, the table 24 may serve as a solid support device operationally configured to be connected to the transport 14 for lifting and moving an individual 200 or other items thereon.

One suitable the lift system includes a winch type device for raising and lowering the safety harnesses 26. One suitable winch type device may include an electric cable hoist as is known in the art. In one embodiment, the winch type device or devices may be enclosed within the transport 14. The transport 14 may be powered via a combustible motor or electric motor or operated manually as desired. Since the system 100 may be built to scale, there are not necessarily any weight constrictions placed on the transport 14 and lift system provided. In one suitable embodiment for lifting and transporting most individuals, the transport 14 is operationally configured to lift and transport up to about 454.00 kg (about 1000.00 pounds), which is an upper weight limit of the most obese of individuals 200. In addition, the transport 14 may include a weight type sensor to detect undesired weights greater than preset weight limits programmed into the transport 14 circuitry.

One particular use of the transport 14 may include lifting an individual 200 off from his/her mattress 18 in order to move the mattress to expose the first compartment 15 underneath. The mattress 18 may be manually moved by another person or the system 100 may be operationally configured to move the mattress 18 via a mechanical or automated system that may lift and/or rotate the mattress 18 in a manner effective to expose the first compartment 15. When employing a mechanical or automated system 100, it is contemplated that the system 100 may be provided with one or more sensors operationally effective to control movement of the mattress 18. For example, the mattress 18 may include a weight detection sensor whereby the mattress 18 will not move unless the absence of a predetermined amount of weight upon the mattress is detected by a sensor. Likewise, the system 100 may include an obstruction type sensor, for example, one or more sensors located along the support beams 10 whereby the mattress 18 will not move if one or more of the sensors detect one or more items located at the target resting spot for a mattress 18 off from the first compartment 15.

In an embodiment including a bath tub 15 for supporting a mattress 18 there upon, the transport 14 may be operationally configured to raise an individual 200 up off of the mattress 18 as shown in FIG. 4. Once the mattress 18 has been moved to expose the opening to the bath tub 15, the transport 14 may be operationally configured to lower the individual 200 into the bath tub 15 for bathing or therapeutic purposes as shown in the simplified example of FIG. 5. As FIG. 5 further depicts, the mattress 18 is set adjacent the bath tub 15 while the individual 200 makes use of the bath tub 15.

As shown in FIGS. 6 and 7, the table 24 is operationally configured to be moved clear of the path of the individual 200 being lifted by the transport 14. In addition, the bath tub 15 may include a permanent or removable seating apparatus as desired. In addition, the system 100 may include a shower head 32 and plumbing in communication there with. Likewise, the bath tub 15 may include one or more drains as desired. Also, the bath tub 15 may be equipped with whirlpool type jet ports for therapeutic applications. As mentioned above, the bath tub side wall may include one or more water dumps 20 for removing water especially in emergency situations. Thus, the one or more water dumps 20 may be manually opened and/or automatically opened upon the triggering of a switch or other device known in the art. Water may flow freely out past the one or more water dumps 20, but it is also contemplated that the one or more water dumps 20 may be operationally configured to receive a hose or pipe in sealable connection thereto. Also, the bath tub 15 may be equipped with one or more temperature sensors to provide information as to the temperature of the water contained within the bath tub 15 at any given moment. One or more water volume sensors may also be employed to automatically turn off the water supply to the bath tub 15 once a predetermined water level is realized. Timers and other sensors may be employed as desired for automatic bathing of an individual 200. Thus, in one embodiment a timer may automatically turn on (1) the transport 14 and any mechanism or system for moving the mattress 18 and table 24 and (2) a water supply for filling the bath tub 15 up to a predetermined level and/or at a predetermined temperature. In still another embodiment the seating apparatus may include one or more sensors for detecting the presence of an individual seated atop the seating apparatus. As such, the system 100 may be programmed so that an individual must be detected as being seated upon the seating apparatus before the system 100 will activate the water supply. Likewise, the bath tub 15 base may include one or more sensors for detecting an individual 200 standing in the bath tub 15 before activating the water supply to a shower head 32 or like device. Sensors described herein may be overridden or otherwise bypassed for manual operation as desired. The bath tub 15 may also be provided with one or more hand rails or the like as desired.

Also, in an embodiment of the system 100 including a shower head 32 or similar device, one or more partitions, drapes or shower curtains may be employed to provide privacy to the individual 200 during use of the bath. Such privacy measures may also be employed to assist an individual for sleeping, studying and other privacy related purposes. In one embodiment, shower curtains may be suspended from the upper support beams 10 and/or cross beams 12. In another embodiment, a rod like device as is common in the field of curtains and drapes may be attached to the framework assembly as desired for suspending one or more partitions, drapes or shower curtains there from.

Turning now to FIGS. 8 and 9, the transport 14 is positioned in what may be referred to as the “toilet position” of the transport 14 along the cross beams 12. As shown in FIG. 9, the transport 14 has been directed from position “A” located above the mattress 18 and first compartment 15 along the cross beams 12 to position “B” located above the toilet 16 (see directional arrow AA). At position B, the transport 14 is operationally configured to lower and raise an individual 200 to and from the toilet 16 of the system 100. In one embodiment, the toilet 16 may include a weight sensor and/or another type of sensor to detect the presence of an individual atop the toilet 16. Likewise, the transport 14 may be in either electrical or remote communication with the toilet 16 whereby a toilet lid (if present) may only be lifted as the transport 14 is traveling toward position B or once the transport has reached position B. Also, the system 100 may be provided with a program for counting the number of toilet uses for a given period of time. Such information may be useful in determining when to empty any waste collection compartments included as part of the system 100. For reference, see also FIGS. 10 and 11, which illustrate a simplified back view and top view of the system 100 including a transport 14 in the toilet position.

As shown in this simplified illustrations of FIGS. 12 and 13, the system 100 is depicted in what may be referred to as a “wheel chair position” of the transport 14 along the cross beams 12. Here, the transport 14 has been directed from position “A” above the mattress 18 and first compartment 15 along the cross beams 12 to position “C” (see directional arrow BB) located above the landing 17 of the base 5 for receiving a wheelchair 300. In the simplified embodiment of FIG. 13, an individual 200 may be lowered into a wheelchair 300 or other seating apparatus as desired. In the alternative, an individual 200 may be lowered to the surface of the landing 17 as desired. Once the individual 200 is ready to return to his/her mattress 18 or to the toilet 16, the individual 200 may be raised from the wheelchair 300 (or other seating apparatus or landing 17) and directed to position A or B as desired. In one embodiment, the landing 17 may include an anti-slip type surface constructed from one or more anti-slip materials. Hand rails may also be included as desired. Electronics, including remote control systems may also be employed to allow an individual, for example an elderly person, to use the transport and lifting system incorporated therein unassisted. In another embodiment, an additional person may be used to manually direct an individual 200 from position C to either of positions A or B as desired.

The present framework assembly of the system 100 may be constructed from one or more materials as desired. For example, construction materials and/or furniture type materials commonly found in dwellings may be used to construct the framework assembly of the system 100. Suitable materials may include, but are not necessarily limited to metals, woods, plastics, rubbers, composite materials, mineral or stone materials, and combinations thereof. In another embodiment, construction materials may be fire proof as desired.

One or more connecting elements may be used to join the various component parts of framework assembly of the system 100 as desired. For example, the system component parts may be joined via any number of fasteners and/or adhesives. Suitably fasteners may include, but are not necessarily limited to those fasteners known in the construction and furniture industries such as nails, screws, bolts, hinges, rivets, L-brackets and the like, and combinations thereof. It is also contemplated that one or more component parts of the system may include surface configurations for mating purposes. For example, one or more component parts may include male and/or female members for joining component parts together. Likewise, dowels and other peg type members may be used to join one or more component parts. One or more adhesives may also be employed for connecting component parts as desired. It is further contemplated that edges of component part may be rounded or include padding materials to guard against injury to an individual 200 due to slips and falls. In such instances, the system 100 may also be provided with one or more alarms or similar switches at low elevations along the system 100 component parts to alert other persons such as legal authorities, family members, caretakers and the like in a situation where an individual 200 has fallen to the surface of the base 5, is injured and/or cannot make use of the transport 14.

Plumbing materials may include metals and/or plastics as commonly used in plumbing applications. Thus, the system 100 may be constructed to meet one or more building codes required for plumbing, electrical wiring, power supplies, lighting, fire sprinklers and smoke alarms attached to the system 100.

Although the system 100 may be built to scale, one suitable system is operationally configured to fit within a room having a ceiling of about 2.4 meters (about 8.0 feet) in height. The base 5 may be provided as one solid piece or formed in sections in order to determine the surface area to be used. Thus, the base 5 sections may include tongue and groove connections or puzzle type fittings. Base 5 sections may be proved in lengths and widths as desired.

The system 100 may be configured to provide for wireless communication and/or wired communication of electronic equipment contemplated for use with the system 100. As new technologies are made available, the framework assembly and mobile transport member of the system 100 may be retrofit as desired.

While the invention has been described with reference to an exemplary embodiment or embodiments, it will be understood by those skilled in the art that various changes may be made and equivalents may be substituted for elements thereof without departing from the spirit and scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. The embodiment(s) described herein are meant to be illustrative only and should not be taken as limiting the invention, which is defined in the claims.

We claim:

1. A system comprising:
a framework assembly defined by a width including a first location operationally configured for a user of the system to perform one or more activities at said first location and at least a second location operationally configured for a user to perform one or more activities at said second location; and
a transport member in communication with the framework assembly, the transport member being operationally configured to move a user between locations of the framework assembly.

2. The system of claim 1 wherein the framework assembly is operationally configured to direct the transport member according to one or more particular paths along the framework assembly.

3. The system of claim 1 wherein the framework assembly includes a location defined by bedding.

4. The system of claim 1 wherein the framework assembly includes a location defined by a toilet.

5. The system of claim 1 wherein the framework assembly includes a location defined by a bath.

6. The system of claim 1 further including plumbing in fluid communication with external plumbing.

7. The system of claim 4 further including plumbing in fluid communication with external plumbing.

8. The system of claim 5 further including plumbing in fluid communication with external plumbing.

9. The system of claim 1 wherein the system is configured to provide for wireless communication of one or more electronic devices.

10. The system of claim 1 including a bath operationally configured to support bedding thereon.

11. The system of claim 1 wherein the one or more activities at said first location include activities performed by a user at different elevations within the framework assembly.

12. A system for assisting persons with performing daily activities comprising:
a framework assembly having one or more covert spaces; and
a transport member in communication with the framework assembly, the transport member being operationally configured to move a user along the framework assembly.

13. The system of claim 12 wherein one or more covert spaces includes a first mattress and bath combination.

14. The system of claim 13 further including a second mattress and bath combination.

15. The system of claim 12 wherein the framework assembly includes a base, support beams attached to the base and one or more cross beams attached to the support beams, the one or more covert spaces being located under the one or more cross beams.

16. The system of claim 15 wherein the transport member is in communication with the one or more cross beams in a manner effective to transport an individual from a first location along the framework assembly to at least a second location along the framework assembly, the transport member being operationally configured to lift and lower an individual from an altitude just below the one or more cross beams to the base.

17. The system of claim 12 wherein the framework assembly is operationally configured to be disassembled and reassembled.

18. The system of claim 12 wherein at least covert space is in fluid communication with an outside water source.

19. A method of assisting one or more persons with daily activities, the method comprising:
providing one or more persons with a system including (1) a framework assembly having one or more facilities and (2) a transport member in communication with the framework assembly, the transport member being operationally configured to move a user along the framework assembly in a manner effective to access the one or more facilities.

20. The method of claim 19 wherein the one or more facilities are selected from the group consisting of bedding, toilets, toilet paper dispensers, sinks, trash receptacles, mirrors, dirty clothes hampers, baths, closet space, stands, table tops, entertainment systems, light sources, communication items, electric outlets, alarm signals, microphones, speakers, access points for gaining access to one or more mobility assistance devices, ramp type devices for receiving rolling devices, and combinations thereof.
